(19) United States
(12) Patent Application Publication
(10) Pub. No.: US 2017/0087773 A1
(43) Pub. Date: Mar. 30, 2017

(54) APPARATUS FOR HORIZONTALLY ALIGNING BED OF THREE-DIMENSIONAL PRINTER

(71) Applicant: HYVISION SYSTEM INC., Seongnam-si, Gyeonggi-do (KR)

(72) Inventors: Doowon CHOI, Incheon (KR); Jun Seok SEO, Seongnam-si (KR)

(73) Assignee: HYVISION SYSTEM INC., Seongnam-si, Gyeonggi-do (KR)

(21) Appl. No.: 15/315,798

(22) PCT Filed: Sep. 22, 2014
(86) PCT No.: PCT/KR2014/008766

§ 371 Date: Dec. 2, 2016

(30) Foreign Application Priority Data
Jun. 3, 2014 (KR) 10-2014-0067478
Sep. 19, 2014 (KR) 10-2014-0125026

(51) Int. Cl. B29C 67/00; B33Y 50/02; B33Y 30/00

(52) U.S. Cl. CPC B29C 67/0088; B33Y 30/00; B33Y 50/02

(57) ABSTRACT

Disclosed is an apparatus for horizontally aligning a bed of a three-dimensional printer, the apparatus enhancing quality of a 3D object produced on the bed, by tilting the bed on two axes so as to horizontally align the bed before operating the three-dimensional printer. The three-dimensional printer produces the 3D object by depositing materials on the bed with an extrusion head, the apparatus including a tilting unit tilting the bed on two axes to horizontally align the bed, when the bed is not horizontal.

### TECHNICAL FIELD

The present invention relates generally to an apparatus for horizontally aligning a bed of a three-dimensional printer, the apparatus horizontally aligning the bed on Which a 3D object is printed, before printing a 3D object.

### BACKGROUND ART

A three-dimensional printer is a device producing life-sized forms of machine parts, etc. from computer files designed by computer-aided design (CAD) program. In recent years, manufacturers have paid particular attention to the three-dimensional printer's development and popularization.

Generally, a three-dimensional printer produces a 3D object by printing and depositing materials (usually, ABS resin) on a print bed (substrate bed) through a nozzle of an extrusion head. The materials are deposited on a designated position of the bed by moving the bed (alternatively, moving extrusion head) in X-, Y-, and Z-axial directions or in certain directions of a Cartesian coordinate system relative to the extrusion head. The moving of the bed in each of the directions is precisely controlled by screws coupled to the bed, etc. such that the materials are accurately deposited on the designated position. However, a process of producing the 3D object by depositing resins is performed at a high temperature. In addition, during the process, the bed moves considerably, and receives an external force from the extrusion head.

Hereinafter, FIG. 1 is a view showing a bed inclined relative to a horizontal axis. As shown in FIG. 1, after the operation of the three-dimensional printer, heat caused by the high temperature of the operation environment, many movements of the bed, and the weight of the bed influence the position of the bed. Consequently, after the operation, the bed may not be aligned to an initial position thereof due to thermal deformation, vibrations, the weight of the bed, etc.

Therefore, it is required to horizontally align the initial position of the bed 20 before producing the 3D object on the bed 20 with the extrusion head 10.

### DISCLOSURE

### Technical Problem

Accordingly, the present invention has been made keeping in mind the above problems occurring in the related art, and the present invention is intended to propose an apparatus for horizontally aligning a bed of a three-dimensional printer, the apparatus enhancing quality of a 3D object produced on the bed, by tilting the bed on two axes so as to horizontally align the bed before operating the three-dimensional printer.

### Technical Solution

In order to achieve the above object, according to one aspect of the present invention, there is provided an apparatus for horizontally aligning a bed of a three-dimensional printer, wherein the three-dimensional printer produces a3D object by depositing materials on the bed with an extrusion head, the apparatus including: a tilting unit tilting the bed on two axes to horizontally align the bed, when the bed is not horizontal. In this case, the apparatus may include a main plate horizontally fixed, and the tilting unit may tilt with the bed on the two axes relative to the main plate.

According to a first exemplary embodiment of the present invention, the tilting unit may include: a first tilting plate coupled to the main plate, and tilting on a first axis of a horizontal plane; a second tilting plate coupled to the first tilting plate, and tilting on a second axis of a horizontal plane, the second tilting plate on which the bed is provided; a first actuator tilting the first tilting plate on the first axis; and a second actuator tilting the second tilting plate on the second axis.

In this case, the first actuator may move a first point of the first tilting plate in a vertical direction, the second actuator may move a second point of the second tilting plate in a vertical direction, and the first point may be located on a line parallel to the second axis on the first tilting plate, and the second point is located on a line parallel to the first axis on the second tilting plate.

The first actuator may include: a first motor provided on the main plate; a first cam rotatably coupled to the first motor; and a first moving part being moved in a vertical direction by a cam profile of the first cam, thereby moving the first point of the first tilting plate in the vertical direction, when the first cam is rotated. In the same mariner as the first actuator, the second actuator may include: a second motor provided on the first tilting plate; a second cam rotatably coupled to the second motor; and a second moving part being moved in a vertical direction by a cam profile of the second cam, thereby moving the second point of the second tilting plate in the vertical direction, when the second cam is rotated.

In the meantime, the apparatus may include: a first buffer spring having a first end fixed to the main plate and a second end fixed to the first tilting plate; and a second buffer spring having a first end fixed to the first tilting plate and a second end fixed to the second tilting plate.

According to a second exemplary embodiment of the present invention, the tilting unit may include a tilting coupling member coupling the bed to the main plate such that the bed is capable of tilting on the two axes.

The tilting coupling member may include: a first coupling piece coupled to the main plate; a second coupling piece coupled to the bed; and a center coupling piece coupled to the first coupling piece to be capable of tilting on a first axis, and coupled to the second coupling piece to be capable of tilting on a second axis.

The first coupling piece may be provided with a bracket located at each of opposite ends of the first coupling piece so as to be coupled to the center coupling piece by using a third rotary shaft extending along the second axis, the bracket of the first coupling piece extending to cross the second axis by being bent, and partially surrounding the center coupling piece. The second coupling piece may be provided with a bracket located at each of opposite ends of the second coupling piece so as to be coupled to the center coupling piece by using a fourth rotary shaft extending along the first axis, the bracket of the second coupling piece extending to cross the first axis by being bent, and partially surrounding the center coupling piece.

The first coupling piece may be integrally provided with the main plate, and is provided with a bracket so as to couple the main plate to the center coupling piece by using a third rotary shaft extending along the second axis, the bracket of the first coupling piece extending to cross the second axis. The second coupling piece may be integrally provided with the bed, and is provided with a bracket so as to couple the bed to the center coupling piece by using a fourth rotary shaft extending along the first axis, the bracket of the second coupling piece extending to cross the first axis.

In the meantime, the main plate may include: a first actuator tilting the bed on a first axis of the two axes of a horizontal plane; and a second actuator tilting the bed on a second axis of the two axes of the horizontal plane.

In this case, the first actuator may include: a first motor provided on the main plate; and a first cam rotatably coupled to the first motor, wherein when the first cam is rotated a first point of a lower surface of the bed is moved in a vertical direction by operation of the first cam. In addition, the second actuator may include: a second motor provided on the main plate; and a second cam rotatably coupled to the second motor, wherein when the second cam is rotated, a second point of the lower surface of the bed is moved in a vertical direction by operation of the second cam.

In addition, the apparatus may include a controller moving the extrusion head, and moving the tilting unit on two axes, wherein the controller measures heights of a plurality of points of the bed, and measures a slope of the bed relative to the two axes, and moves the tilting unit to horizontally align the bed.

In this case, the controller may initialize an original point of the bed by moving the extrusion head on a point of the bed up to a time when a nozzle of the extrusion head comes into contact with an upper surface of the bed, and may calculate a slope of the bed relative to a horizontal plane by moving the extrusion head between the plurality of points of the bed, and by measuring coordinates of the plurality of points relative to the original point, and may tilt the bed to supplement the measured slope so as to horizontally align the bed.

The original point may be a center point of the bed.

### Advantageous Effects

According to the apparatus for horizontally aligning the bed of the three-dimensional printer, the apparatus can horizontally align the bed inclined relative to a horizontal plane by quickly tilting the bed, which a 3D object is produced on, on two axes so as to provide the bed parallel with the main plate of the three-dimensional printer.

Therefore, the apparatus can enhance qualify of the 3D object by horizontally aligning the bed of the three-dimensional printer.

### DESCRIPTION OF DRAWINGS

FIG. 1 is a view showing a bed, which a 3D object is produced on, inclined relative to a horizontal plane;

FIG. 2 is a view showing an apparatus for horizontally aligning a bed of a three-dimensional printer according to a first exemplary embodiment of the present invention;

FIG. 3 is a view showing a first tilting plate, that tilts on X-axis, of the apparatus of FIG. 2;

FIG. 4 is a view showing a second tilting plate, that tilts on Y-axis, of the apparatus of FIG. 2;

FIG. 5 is a view showing the first tilting plate and driving components of FIG. 2;

FIG. 6 is a view showing the first tilting plate and buffering components of FIG. 2;

FIG. 7 is a view showing operation of a cam tilting the first tilting plate of FIG. 2;

FIG. 8 is a schematic view showing a process of measuring a position and slope of the bed by using an extrusion head of the apparatus;

FIG. 9 is a view showing an apparatus for horizontally aligning a bed of a three-dimensional printer according to a second exemplary embodiment of the present invention;

FIG. 10 is a view showing a two axes tilting assembly of FIG. 9; and

FIG. 11 is an exploded perspective view showing the two axes tilting assembly of FIG. 10.

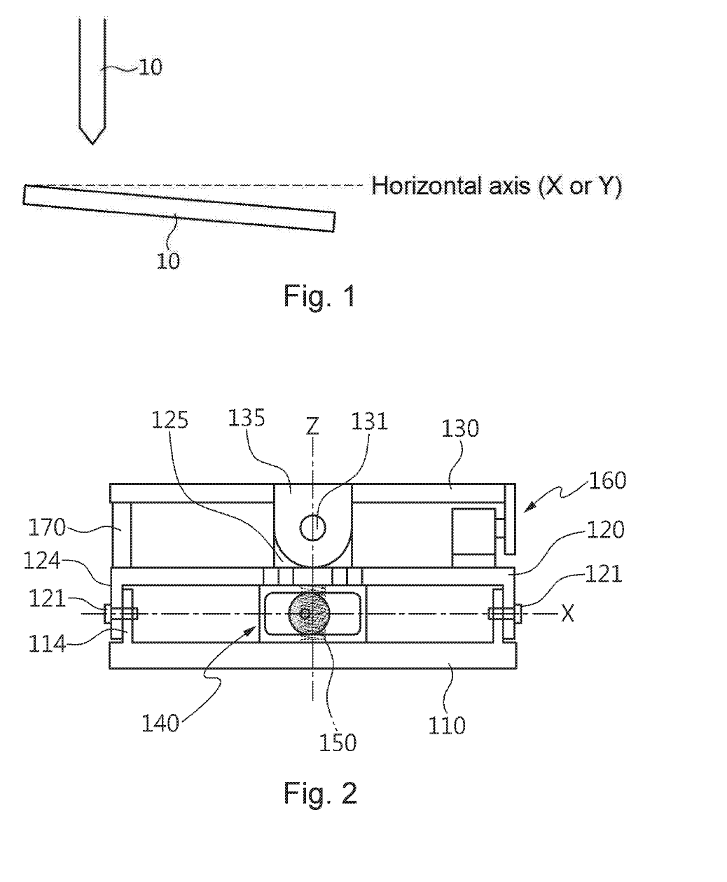

DESCRIPTION OF MAIN REFERENCE NUMERALS OF DRAWINGS

| | |
|---|---|
| 210: main plate | 220: bed |
| 230: first actuator | 231: first cam |
| 240: second actuator | 241: second cam |
| 300: tilting coupling member | 310: first bracket |
| 320: second bracket | 330: center coupling piece |

### MODE FOR INVENTION

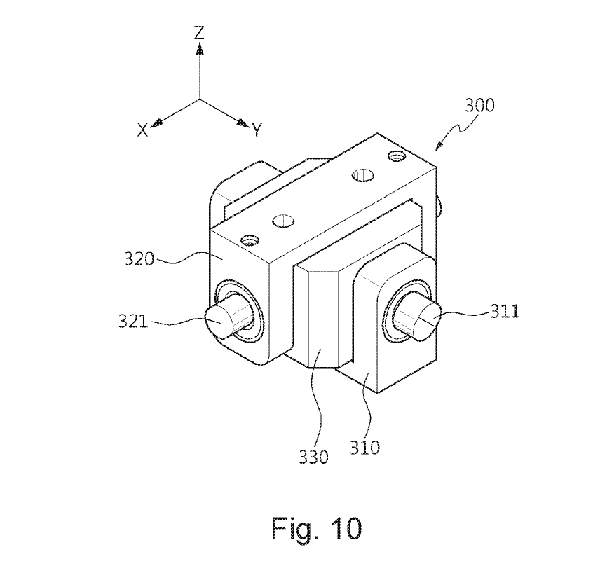

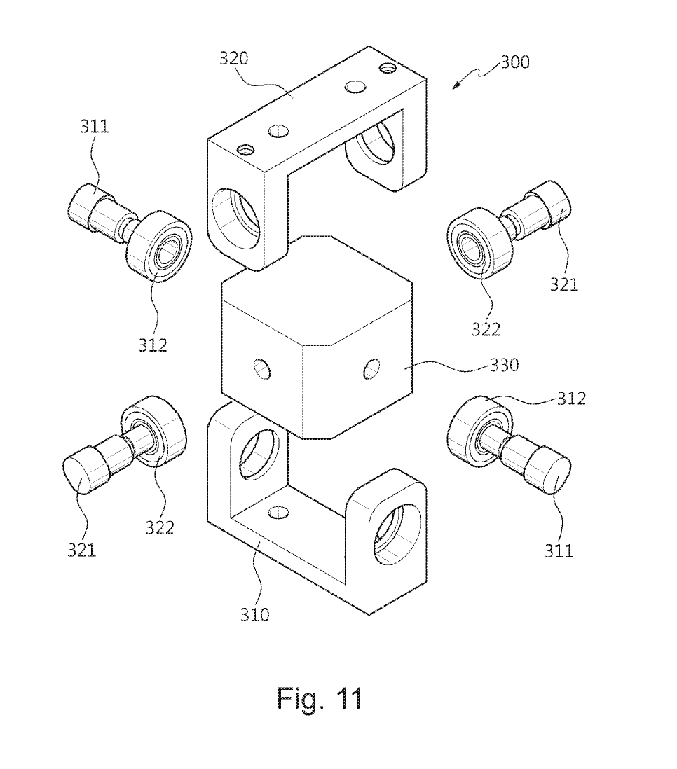

Hereinbelow, exemplary embodiments of the present invention will be described in detail with reference to FIGS. 2 to 11. It should be understood that the exemplary embodiments of the present invention may be changed to a variety of embodiments and the scope and spirit of the present invention are not limited to the exemplary embodiments described hereinbelow. In addition, it should be understood that the shape and size of the elements shown in the drawings may be exaggeratedly drawn to provide an easily understood description of the structure of the present invention. Throughout the drawings, the same reference numerals will refer to the same or like parts.

In addition, it should be understood that when an element is referred to as being “coupled” or “connected” to another element, it can be directly coupled or electrically connected to the other element or intervening elements may be present therebetween. Unless the context clearly indicates otherwise, it will be further understood that the terms “comprises”, “comprising”, “includes”, and/or “Including”, when used herein, specify the presence of stated features, integers, steps, operations, elements, and/or components, but do not preclude the presence or addition of one or more other features, integers, steps, operations, elements, components, and/or groups thereof.

FIGS. 2 to 7 show an apparatus for horizontally aligning a bed of a three-dimensional printer according to the first exemplary embodiment of the present invention. As shown in FIG. 2, the three-dimensional printer uses a controller (not shown) to control a position and slope of a bed. The controller uses a stereo lithography (STL) file to produce a 3D object on the bed of a bed assembly.

The apparatus for horizontally aligning the bed includes a first tilting plate 120 and a second tilting plate 130 as two single-axis tilting components that function as parts of a tilting unit and respectively tilt top surfaces thereof on certain axes on a main plate 110. The first tilting plate tilts on the X-axis that functions as a first axis, and the second tilting plate tilts on the Y-axis that functions as a second axis. The main plate 110 moves in a horizontal axis (X-axis or Y-axis) direction and a vertical axis (Z-axis) direction, and determines a position thereof relative to an extrusion head (not shown). The second tilting plate 130 is a top bed on which the 3D object is deposited by the extrusion head.

The first tilting plate 120 is tiltably coupled to the main plate 110 by a first rotary shaft 121. The first rotary shaft 121 is coupled to the main plate 110 in the X-axial direction such that the first tilting plate 120 may tilt on the first rotary Shaft 121 relative to the main plate 110.

The second tilting plate 130 is tiltably coupled to the first tilting plate 120 by a second rotary shaft 131. The second rotary shaft 131 is coupled to the first tilting plate 120 in the Y-axial direction such that the second tilting plate 130 may tilt on the second rotary shaft 131 relative to the first tilting plate 120.

The main plate 110 has a first bracket 114 formed thereon. The first bracket protrudes in the Z-axial direction of an YZ-plane. The first tilting plate 120 has a second bracket 124 formed thereon. The second bracket protrudes downwardly in the Z-axial direction of the YZ-plane. The first rotary shaft 121 is rotatably coupled to the first bracket 114 and the second bracket 124 by passing therethrough in the X-axial direction. Therefore, the first tilting plate 120 may tilt on the first rotary shaft 121 that is the X-axis.

The first tilting plate 120 has a third bracket 125 formed thereon. The third bracket protrudes in the Z-axial direction of a ZX-plane. The second tilting plate 130 has a fourth bracket. 135 formed thereon. The fourth bracket protrudes downwardly in the Z-axial direction of the ZX-plane. The second rotary shaft 131 is rotatably coupled to the third bracket 125 and the fourth bracket 135 by passing therethrough in the Y-axial direction. Therefore, the second tilting plate 130 may tilt on the second rotary shaft 131 that is Y-axis.

The first bracket 114 is formed on the main plate, and the second bracket 124 is formed on the first tilting plate 120. The first rotary shaft 121 is rotatably coupled to the first bracket 114 and the second bracket 124 by passing therethrough in the X-axial direction. Therefore, the first tilting plate 120 may tilt on the first rotary shaft 121 that is the X-axis.

A first actuator 140 that functions as a part of a tilting unit is provided on the main plate 110. The first actuator flits the first tilting plate 120 on the X-axis. A second actuator 160 that functions as a part of a tilting unit is provided on the first tilting plate 120. The second actuator tilts the second tilting plate 130 on Y-axis. The first actuator 140 moves a first end portion that functions as first point located on a line parallel to the second axis on the first tilting plate of the first tilting plate 120 in the Z-axial direction such that the first tilting plate 120 may be tilted on the first rotary shaft 121. In the same manner as the first actuator, the second actuator 160 moves a first end portion that functions as a second point located on a line parallel to the first axis on the second tilting plate of the second tilting plate 130 in the Z-axial direction such that the second tilting plate 130 may be tilted on the second rotary shaft 131.

A first buffer spring 150 is provided on a second end portion (opposite end portion from the first actuator 140 about the first rotary shaft 121) of the first tilting plate 120. When the first tilting plate 120 is tilted by the first actuator, the first buffer spring absorbs the shock, and minimizes a tolerance of the bed with elasticity during the operation/non-operation of the bed.

In the same manner as the first buffer spring, a second buffer spring 170 is provided on a second end portion (opposite end portion from the second actuator 160 about the second rotary shaft 131) of the second tilting plate 130.

According to the first exemplary of the present invention, the first and second actuators 140 and 160 are actuators using respective cams that functions as first and second cams. The first and second actuators respectively move the first end portions of the first and second tilting plate 120 and 130 in the Z-axial direction by using the respective cams.

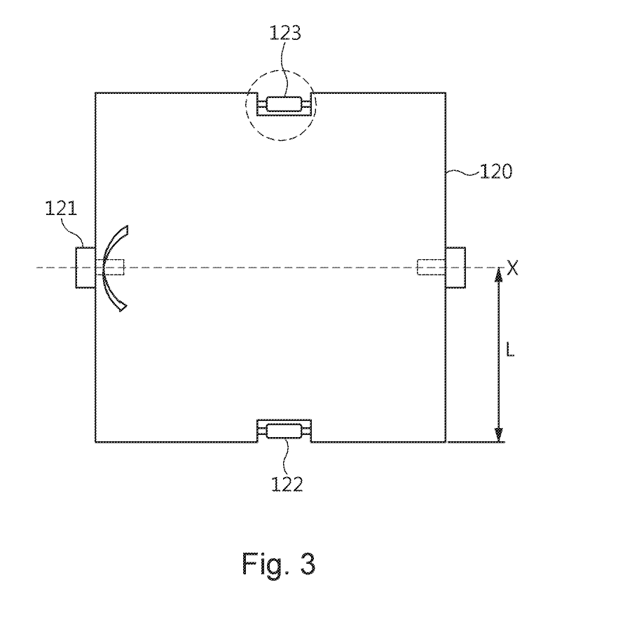

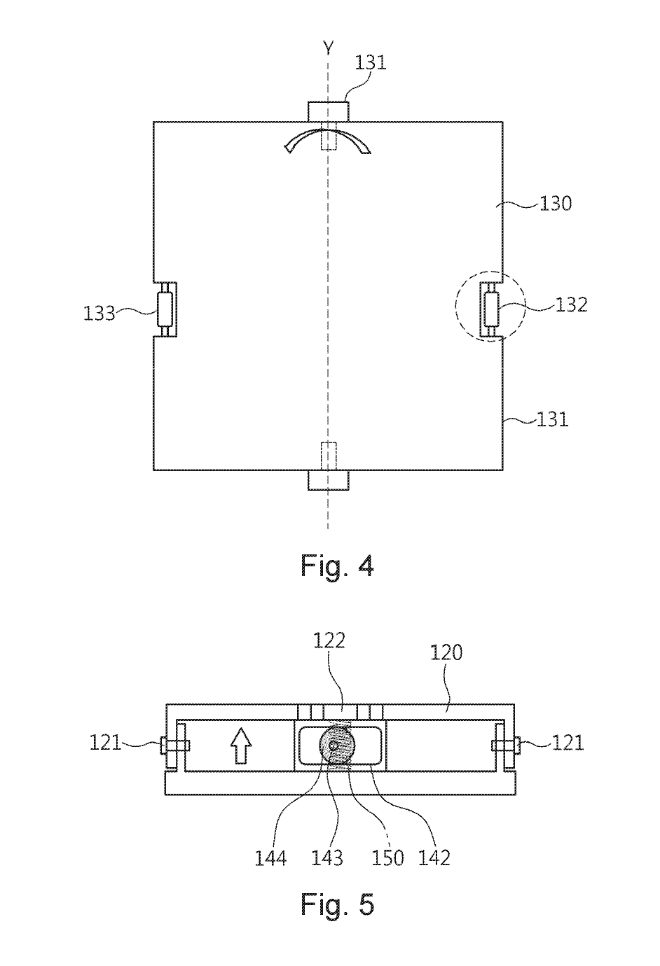

As shown in FIGS. 3 and 4, a first actuator contacting part 122 is provided on the first end portion of the first tilting plate 120. The first actuator contacting part is in contact with the first actuator 140, when the first actuator moves in the Z-axial direction. A first buffer spring coupling part 123 coupled to the first buffer spring 150 is provided on the second end portion of the first tilting plate. In the same manner as the first tilting plate, a second actuator contacting part 132 and a second buffer spring coupling part 133 are provided on the second tilting plate 130.

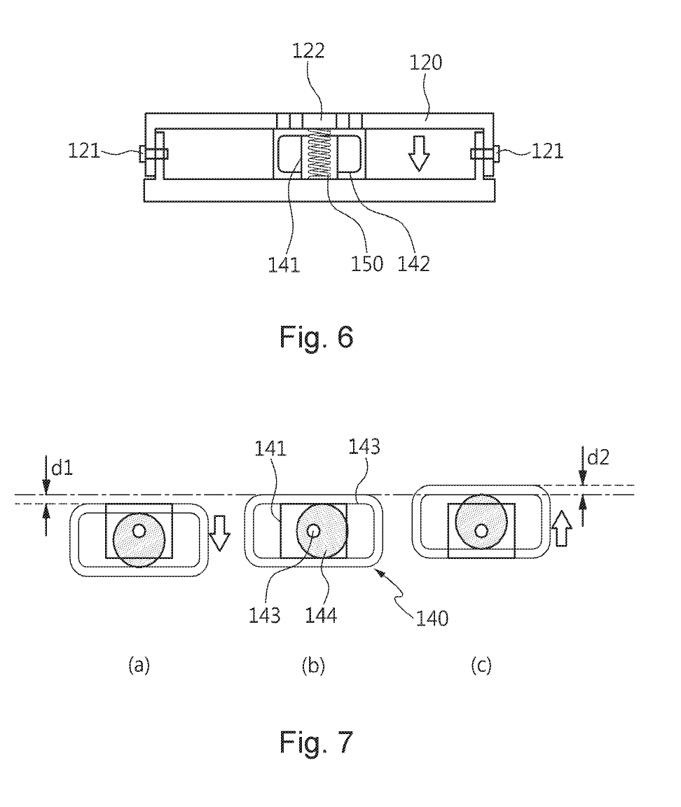

As shown in FIGS. 5 and 6, the first buffer spring 150 has a first end fixed to the main plate 110, and has a second end fixed to the first buffer spring coupling part 123 of the first tilting plate 120. The first buffer spring is compressed when the first actuator 140 moves the first end portion of the first tilting plate 120 upwardly in the Z-axial direction. However, the first buffer spring is tensioned when the first actuator moves the first end portion of the first tilting plate downwardly in the Z-axial direction. In the same manner as the first buffer spring, the second buffer spring 170 has a first end fixed to the first tilting plate 120, and has a second end fixed to the second buffer spring coupling part 133 of the second tilting plate 130. The second buffer spring is compressed when the second actuator 160 moves the first end portion of the second tilting plate 130 upwardly in the Z-axial direction. However, the second buffer spring is tensioned when the second actuator moves the first end portion of the second tilting plate downwardly in the Z-axial direction.

As shown in FIG. 7, the first actuator 140 includes a motor 141 that functions as a first motor and is provided on the main plate 110; a cam shaft 143 rotating with a rotary shaft of the motor 141; a cam 144 that functions as a first cam and has the cam shaft 143 as an eccentric shaft to be capable of rotating; and a moving part 142 that functions as a first moving part and which moves in a vertical direction, which is the Z-axial direction, by a cam profile of the cam 144. The moving part 142 is in contact with the first actuator contacting part 122 of the first tilting plate 120.

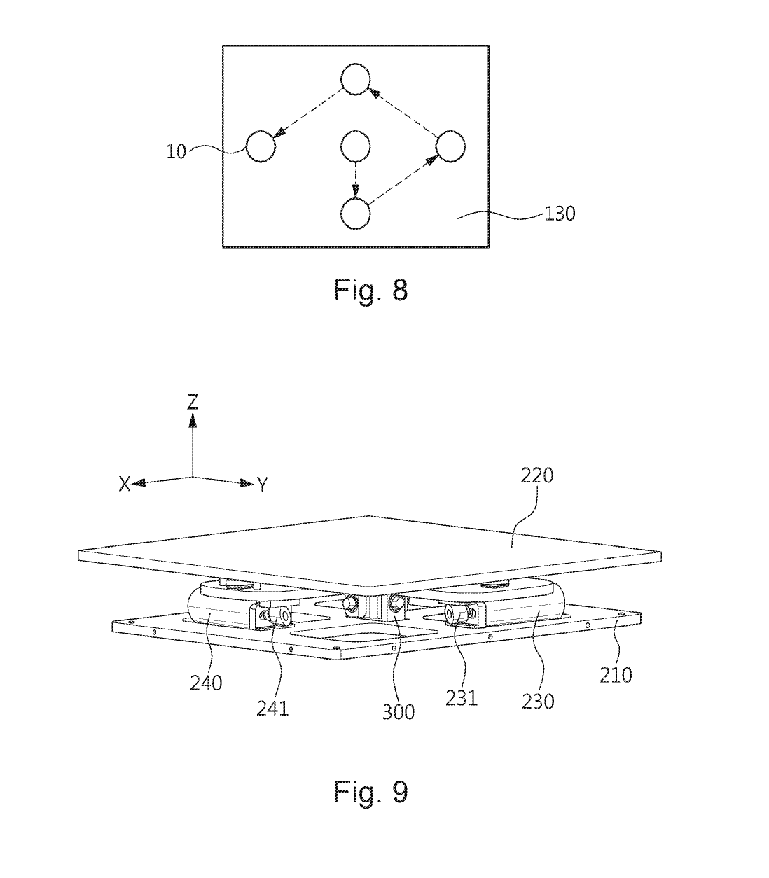

When the first tilting plate 120 is parallel to an XY-plane, the cam 144 is located as shown in FIG. 7(b). As shown in FIG. 7(c), when the cam shaft 143 is rotated to cause the cam 144 to move the moving part 142 upwardly in the Z-axial direction as much as d2, the first tilting plate 120 tilts on the X-axis as much as sin⁻¹ d2/L. On the other hand, as shown in FIG. 8(a), when the cam shaft 143 is rotated to cause the cam 144 to move the moving part 142 downwardly in the Z-axial direction as much as d1, the first tilting plate 120 tilts on the X-axis as much as −sin⁻¹ d1/L. The second actuator 160 tilts the second tilting plate 130 on the Y-axis. The operation of the second actuator is the same as those of the first actuator 140, and thus, a detailed description of the second actuator will be omitted.

According to the first exemplary of the present invention, the cam profile of the cam 144 is a circular shape having an asymmetric center. However, the cam profile is an illustrative example. The cam profile includes a cam profile being capable of moving the moving part 142 in a vertical direction depending on the rotation of the cam shaft 143 as well as precisely controlling a displacement of the moving part 142 by controlling the rotation of the motor 141, without being limited thereto.

FIG. 8 shows a process of calculating a slope of the second tilting plate 130, on which the 3D object is produced, by using the extrusion head. Initially, the controller (not shown) moves the head 10 on the center point of an XY-plane of the second tilting plate 130, which is a print bed. When the head is located on the center, the apparatus is moved in the Z-axial direction, up to the time when the apparatus comes into contact with a nozzle that is the fore-end of the extrusion head 10. The apparatus moves slightly downwardly so as to initialize the zero point of the Z-axis.

Next, the extrusion head 10 is moved in the X-axial direction and the Y-axial direction from the initial point on the XY-plane, and the Z-axis position of the moved point is measured. When measuring the Z-axis height of the moved point spaced apart from the initial point in the X-axial direction, it is possible to calculate how much the second tilting plate 130 is inclined on the Y-axis by using inverse trigonometric functions. In the same manner as described above, when measuring the Z-axis height of the moved point spaced apart from the initial point in the Y-axial direction, it is possible to calculate how much the second tilting plate is inclined on the X-axis.

FIG. 8 shows an illustrative example of the process of calculating the slope of the second tilting plate relative to the X-axis and the Y-axis by measuring Z-axis heights of five points including the initial point with the extrusion head. Therefore, the method of calculating the slope of the second tilting plate is not limited thereto, and the points for the measuring are not limited to the five points.

After the measuring of the slope, the controller (not shown) operates the first actuator 140 and the second actuator 160 to tilt the second tilting plate 130 on two axes, thereby horizontally aligning the second tilting plate 130 to be parallel to the XY-plane.

FIGS. 9 to 11 show the apparatus for horizontally aligning the bed of the three-dimensional printer according to the second exemplary embodiment of the present invention.

As shown in FIG. 9, the apparatus includes a main plate 210, a bed 220, and a single two-axes tilting component tilting the bed 220 relative to the main plate 210. That is, the first exemplary embodiment uses two single-axis tilting components for two-axes tilting, while the second exemplary embodiment uses the single two-axes tilting component.

The single two-axes tilting component includes a tilting coupling member 300 coupling the main plate 210 to the bed 220 such that the bed is capable of tilting on two axes. The main plate 210 includes a first actuator 230 tilting the bed 220 on the X-axis of a horizontal plane, and a second actuator 240 tilting the bed 220 on the Y-axis of the horizontal plane. According to the second exemplary embodiment of the present invention, in order to tilt the bed 220 on the X-axis, the first actuator 230 include a first cam 231 moving positions in a vertical direction. The positions are perpendicular to the X-axis on the bed 220 about the tilting coupling member 300. In the same manner as the first actuator, in order to tilt the bed 220 on the Y-axis, the second actuator 240 includes a second cam 241 moving positions in a vertical direction. The positions are perpendicular to the Y-axis on the bed 220 about the tilting coupling member 300.

According to the second exemplary of the present invention, the first and second actuators 230 and 240 are servomotors that functions as first and second motors, and the first and second cams 231 and 241 are cams eccentrically rotating around respective rotary shafts of the servomotors.

When calculating the slope of the bed, angles of the bed 220 inclined relative to the X-axis and the Y-axis are calculated. The first cam 231 and the second cam 241 tilt the bed 220 in opposite directions of the respective calculated angles as much as the calculated angles. Consequently, the bed 220 is horizontally aligned.

Hereinafter, a configuration and an operation for two-axes tilting will be described in detail.

The tilting coupling member 300 includes a first bracket 310 that functions as a first coupling piece and is coupled to the main plate 210; a second bracket 320 that functions as a second coupling piece and is coupled to the bed 220; and a center coupling piece 330. The center coupling piece is coupled to the first bracket 310 to be capable of tilting on the X-axis, and is coupled to the second bracket 320 to be capable of tilting on the Y-axis. The first bracket 310 is tiltably coupled to the center coupling piece 330 by a third rotary shaft 311 rotating on the Y-axis. The second bracket 320 is tiltably coupled to the center coupling piece by a fourth rotary shaft 321 rotating on the X-axis.

According to the second exemplary of the present invention, the center coupling piece 330 has a cube shape. Opposite ends of the first bracket 310 are coupled to the center coupling piece 330 by penetrating the Y-axis of the center coupling piece with the third rotary shaft 311 rotating on the Y-axis. The first bracket partially surrounds the center coupling piece 330. Opposite ends of the second bracket 320 are coupled to the center coupling piece 330 by the fourth rotary shaft 321 rotating on the X-axis. The second bracket partially surrounds the center coupling piece 330. According to the second exemplary of the present invention, the lust and second brackets 310 and 320 have “U” shapes without being limited thereto.

In the meantime, the first bracket 310 is integrally provided with the main plate 210, and may extend from the main plate 210. Also, the second bracket 320 is integrally provided with the bed 220 and may extend from the bed 220.

When the first and second actuators 230 and 241 are operated to rotate the first and second cams 231 and 241, the bed 220 is tilted upwardly by respective cam profiles of the first and second cams 231 and 241. The tilting coupling member 300 freely tilts on the X-axis and the Y-axis such that the bed 220 is horizontally aligned by supplementing the slope of the bed relative to the X-axis and to the Y-axis.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An apparatus for horizontally aligning a bed of a three-dimensional printer that produces a 3D object by depositing materials on the bed with an extrusion head, the apparatus comprising:
a main plate that is horizontally fixed; and
a tilting unit tilting the bed on two axes to horizontally align the bed so as to cause the bed to be parallel with the main plate, when the bed is not horizontal.

2. The apparatus of claim 1, wherein the tilting unit comprises:
a first tilting plate coupled to the main plate, and tilting on a first axis of a horizontal plane;
a second tilting plate coupled to the first tilting plate, and tilting on a second axis of a horizontal plane, the second tilting plate on which the bed is provided;
a first actuator tilting the first tilting plate on the first axis; and
a second actuator tilting the second tilting plate on the second axis.

3. The apparatus of claim 2, wherein the first actuator moves a first point of the first tilting plate in a vertical direction,
the second actuator moves a second point of the second tilting plate in a vertical direction, and
the first point is located on a line parallel to the second axis on the first tilting plate, and the second point is located on a line parallel to the first axis on the second tilting plate.

4. The apparatus of claim 3, wherein the first actuator comprises:
a first motor provided on the main plate;
a first cam rotatably coupled to the first motor; and
a first moving part being moved in a vertical direction by a cam profile of the first cam, thereby moving the first point of the first tilting plate in the vertical direction, when the first cam is rotated.

5. The apparatus of claim 3, wherein the second actuator comprises:
a second motor provided on the first tilting plate;
a second cam rotatably coupled to the second motor; and
a second moving part being moved in a vertical direction by a cam profile of the second cam, thereby moving the second point of the second tilting plate in the vertical direction, when the second cam is rotated.

6. The apparatus of claim 3, further comprising:
a first buffer spring having a first end fixed to the main plate and a second end fixed to the first tilting plate; and
a second buffer spring having a first end fixed to the first tilting plate and a second end fixed to the second tilting plate.

7. The apparatus of claim 1, wherein the tilting unit comprises:
a tilting coupling member coupling the bed to the main plate such that the bed is capable of tilting on the two axes.

8. The apparatus of claim 7, wherein the tilting coupling member comprises:
a first coupling piece coupled to the main plate;
a second coupling piece coupled to the bed; and
a center coupling piece coupled to the first coupling piece to be capable of tilting on a first axis, and coupled to the second coupling piece to be capable of tilting on a second axis.

9. The apparatus of claim 8, wherein the first coupling piece is provided with a bracket located at each of opposite ends of the first coupling piece so as to be coupled to the center coupling piece by using a third rotary shaft extending along the first axis, the bracket of the first coupling piece extending to cross the first axis by being bent, and partially surrounding the center coupling piece, and
the second coupling piece is provided with a bracket located at each of opposite ends of the second coupling piece so as to be coupled to the center coupling piece by using a fourth rotary shaft extending along the second axis, the bracket of the second coupling piece extending to cross the second axis by being bent, and partially surrounding the center coupling piece.

10. The apparatus of claim 8, wherein the first coupling piece is integrally provided with the main plate, and is provided with a bracket so as to couple the main plate to the center coupling piece by using a third rotary shaft extending along the second axis, the bracket of the first coupling piece extending to cross the second axis, and
the second coupling piece is integrally provided with the bed, and is provided with a bracket so as to couple the bed to the center coupling piece by using a fourth rotary shaft extending along the first axis, the bracket of the second coupling piece extending to cross the first axis.

11. The apparatus of claim 7, wherein the main plate comprises:
a first actuator tilting the bed on a first axis of the two axes of a horizontal plane; and
a second actuator tilting the bed on a second axis of the two axes of the horizontal plane.

12. The apparatus of claim 11, wherein the first actuator comprises:
a first motor provided on the main plate; and
a first cam rotatably coupled to the first motor,
wherein when the first cam is rotated, a first point of a lower surface of the bed is moved in a vertical direction by operation of the first cam.

13. The apparatus of claim 12, wherein the second actuator comprises:
a second motor provided on the main plate; and
a second cam rotatably coupled to the second motor,
wherein when the second cam is rotated, a second point of the lower surface of the bed is moved in a vertical direction by operation of the second cam.

14. The apparatus of claim 1, further comprising:
a controller moving the extrusion head, and moving the tilting unit on two axes,
wherein the controller measures heights of a plurality of points of the bed, and measures a slope of the bed relative to the two axes, and moves the tilting unit to horizontally align the bed.

15. The apparatus of claim 14, wherein the controller initializes an original point of the bed by moving the extrusion head on a point of the bed up to a time when a nozzle of the extrusion head comes into contact with an upper surface of the bed,
calculates a slope of the bed relative to a horizontal plane by moving the extrusion head between the plurality of points of the bed, and by measuring coordinates of the plurality of points relative to the original point, and
tilts the bed to supplement the measured slope so as to horizontally align the bed.

16. The apparatus of claim 15, wherein the original point is a center point of the bed.
